(19) United States
(12) Patent Application Publication
(10) Pub. No.: US 2010/0177450 A1
(43) Pub. Date: Jul. 15, 2010

(54) METHOD AND DEVICES FOR STABILIZING ELECTRIC GRID POWER

(75) Inventors: Matthew J. Holcomb, Metamora, MI (US); George Caravias, Basking Ridge, NJ (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: GRID LOGIC, Metamora, MI (US)

(21) Appl. No.: 12/686,258

(22) Filed: Jan. 12, 2010

Related U.S. Application Data
(60) Provisional application No. 61/204,898, filed on Jan. 12, 2009.

(51) Int. Cl. H02H 7/00; H02H 9/00

(52) U.S. Cl. 361/19; 361/58

(57) ABSTRACT

The invention provides an electric grid stabilization metadevice including a plurality of interactive grid devices each forming part of a respective electrical path of an electric grid and each including, a variable impedance device that inserts a current limiting impedance in the respective path when a fault occurs, a state detection transducer connected to the variable impedance device to change a detection state when the fault occurs and an integral communications system having transmission and reception capabilities and being connected to the state detection transducer and variable impedance device, wherein a fault detected by each of the interactive grid devices automatically causes transmission of a signal to another integrated grid device, reception of the signal by the other integrated grid device and an insertion of a current limiting impedance by the other integrated grid device.

### CROSS-REFERENCE TO RELATED APPLICATIONS

This application claims priority from U.S. Provisional Patent Application No. 61/204,898, filed on Jan. 12, 2009, which is incorporated herein by reference in its entirety.

### BACKGROUND OF THE INVENTION

The present invention relates to the control of the electric utility grid through the use of variable impedance devices that respond automatically to destabilizing transients in the electric grid, or respond under active control to improve grid stabilization and power quality.

The efficient and reliable generation, transmission and distribution of electrical power is essential to the security and economy of the United States. Increasing electrical demand, grid interconnections and a growing number of independent power generation facilities have decreased the overall stability of an aging North American electrical grid. This instability frequently manifests itself as an increase in the number of uncontrolled high current surges (i.e. fault currents), which result from flooding, high winds, downed tree limbs, lightning strikes, crossed transmission lines, etc. Left unchecked, fault currents may permanently damage transmission and distribution equipment, trip high-power circuit breakers, and disrupt power flow to end users, causing considerable social and economic impact in the afflicted regions. Significant power blackouts in the United States alone (e.g. Northeast in 2003, Northern California in 2001, Detroit in 2000, Atlanta, New Orleans, Chicago and New York in 1999, US West Coast in 1996, and the US Gulf Coast in 2005) are evidence of the inherent fragility of the North American electrical grid. A recent study on the cost of power interruptions to United States electricity consumers suggest that the economic loss in the United States is on the order of $80 B per year.

Radial distribution networks were designed such that power flowed from the generation source (represented by open circles in FIG. 16) to the end user. Power flows in radial networks in one direction (depicted by the arrows in the Figure), leading from the main feeder branch to side branches that deliver power to the respective loads (represented by solid circles in FIG. 16), which can be individual destinations or downstream substations. Breakers A and B are placed to protect and isolate the main feeder in the event of a short circuit condition (i.e. a fault) in each respective branch. If a fault occurs downstream of Breaker A, for example, the breaker A detects the high current surge and opens after a fixed number of cycles. This behavior serves to “sectionalize” the grid (i.e. it isolates the faulted portion of the electric grid downstream of Breaker A) and preserves the stability of the overall electric grid. In this example, end-users downstream of Breaker B would not experience a power interruption.

Frequently, Breakers A and B are “re-closing” breakers. Re-closing breakers open and re-close on a set time schedule, which is usually determined by the device and the local utility. A typical “re-closing” schedule is shown schematically in FIG. 17. At the onset of the fault event, the breaker detects the current surge for approximately 4 to 6 cycles and automatically opens at or near a zero voltage crossing. The “re-closer” then waits for 4 to 10 cycles and re-closes. If the fault persists, this process is repeated a third time, with a longer time delay in the open state. If the fault persists after the third time, the system is locked out in the “open” state and the fault is considered permanent. The majority of faults clear in the first or second re-closing sequence.

Fault Current Limiters (FCLs) are devices that autonomously detect high current surges in the electrical power network and insert a current limiting impedance many times faster than a conventional circuit breaker, which improves power quality, protects downstream equipment (e.g. transformers, motors, switchgear, circuit breakers, etc.) from potential damage, and prevents power interruptions. The widespread use of FCLs will improve grid stability and allow the grid as a whole to be better able to respond to both transient and permanent faults, which may occur during natural disasters. FCLs have been a long-standing dream of utility-grid electrical power engineers, and a number of devices have been fabricated with varying degrees of success. Reliable, albeit inefficient and bulky, alternative fault control methods (e.g. fast circuit breakers, air core reactors, high impedance transformers, etc.) are typically used in the electrical transmission and distribution grid since high-efficiency, economical fault current limiting devices have yet to be developed.

With the discovery of superconductivity above the temperature of liquid nitrogen (77K) in the High-Temperature Superconductors (HTS) came a tremendous effort aimed at producing useful commercial devices with these materials. Superconducting materials, in principle, are ideal materials for use in FCL devices because the resistance of the material is essentially zero up to a maximum current, known as the critical current (I_{C}). Thus, during normal operation, the FCL does not add additional impedance to the electric grid. When the current flow through the superconductor exceeds I_{C}, however, the material becomes a highly resistive normal material. This superconducting- to normal-state transition may be used in a FCL device to quickly insert significant impedance into the electric grid, which effectively attenuates the magnitude of the fault current. Unfortunately, prototype HTS-based superconducting FCLs have had limited success because of the poor HTS materials properties, the low critical currents of HTS wire and bulk components, and the inherent high cost of the HTS components.

In January 2001, superconductivity was discovered at 39K in Magnesium Diboride (MgB₂). The discovery of superconductivity in this simple metallic compound at over half the temperature of liquid nitrogen stimulated a great interest in this material as an inexpensive, practical alternative to HTS materials for power applications operating at temperatures below 30K. Although this operating temperature is not as desirable as that of HTS materials, recent advances in cryogen-free cooling technologies have made these temperatures economical for the FCL application. Similar to HTS materials, however, MgB₂ is a hard, brittle ceramic material, and suffers many of the same mechanical shortcomings as the HTS ceramics. To date, HTS and MgB₂ superconducting materials do not yet possess the physical and economic characteristics necessary to develop cost-effective, reliable superconducting FCL systems.

FIG. 18 illustrates the operation of a radial grid similar to that in FIG. 16, equipped with Fault Current Limiting devices. FCLs A and B are designed to trigger at some current in excess of the normal load current of the grid. When the FCLs trigger, a current limiting impedance is seamlessly inserted into the grid, which limits the magnitude of the transient fault current. For example, if a fault occurs in the radial branch downstream of FCL A, FCL A quickly inserts an impedance in-line and the current to the faulted branch is limited. FIG. 19A shows schematically the trigger sequence of an FCL device, where is it seen that the current is limited very quickly by the device. Unlike breakers that allow the fault to pass through for 4 to 6 cycles before opening at or near a zero voltage crossing, as seen in FIG. 19B, FCLs are able to insert the current limiting impedance at any point in the cycle and are able to trigger within a single AC cycle.

In the FCL protected radial grid, the feeder voltage does not sag due to the presence of the fault downstream of FCL A because of the inserted impedance of FCL A. Thus, FCL placement in a radial grid improves power quality even without coordination and communication between the devices

### SUMMARY OF THE INVENTION

The invention provides an electric grid stabilization metadevice including a plurality of interactive grid devices each forming part of a respective electrical path of an electric grid and each including, a variable impedance device that inserts a current limiting impedance in the respective path when a fault occurs, a state detection transducer connected to the variable impedance device to change a detection state when the fault occurs and an integral communications system having transmission and reception capabilities and being connected to the state detection transducer and variable impedance device, wherein a fault detected by each of the interactive grid devices automatically causes transmission of a signal to another integrated grid device, reception of the signal by the other integrated grid device and an insertion of a current limiting impedance by the other integrated grid device.

In the electric grid stabilization metadevice, a fault detected by a first of the integrated grid devices may cause automatic transmission of a signal to a second of the integrated grid devices and an insertion of a current limiting impedance by the second integrated grid device.

In the electric grid stabilization metadevice, a fault detected by the second integrated grid device may cause automatic transmission of a signal to the first integrated grid device and an insertion of a current limiting impedance by the first integrated grid device.

In the electric grid stabilization metadevice, a fault detected by the second integrated grid device may cause automatic transmission of a signal to a third of the integrated grid devices and an insertion of current limiting impedance by the third integrated grid device.

In the electric grid stabilization metadevice, a fault detected by the first integrated grid device may cause automatic transmission of a signal to the third integrated grid device and an insertion of a current limiting impedance by the third integrated grid device.

In the electric grid stabilization metadevice, a fault detected by the third integrated grid device may cause automatic transmission of a signal to the second integrated grid device and an insertion of a current limiting impedance by the second integrated grid device.

In the electric grid stabilization metadevice, a fault detected by the third integrated grid device may cause automatic transmission of a signal to the first integrated grid device and an insertion of a current limiting impedance by the first integrated grid device.

In the electric grid stabilization metadevice, the current limiting impedance may allow current to flow through the respective path.

In the electric grid stabilization metadevice, the variable impedance device may include a superconductor branch and a finite impedance shunt branch (e.g. resistive, inductive, capacitive or a combination) in parallel, current passing through the superconductor branch if the current is below a critical current of the superconductor branch, and the current through the superconductor branch being reduced by the superconductor branch if the current exceeds the critical current, to increase an overall impedance of the superconductor branch and the finite impedance shunt branch in parallel.

The electric grid stabilization metadevice may further include an element that is operable to couple and decouple from the superconductor material of the superconductor branch, a change in coupling causing a change in resistance of the superconductor branch, the element being connected to the integral communications system so that the integral communications system operates the element in response to reception of the signal.

In the electric grid stabilization metadevice, the element may be a solenoid element that creates a magnetic field in the superconductor branch when energized.

In the electric grid stabilization metadevice, the state detection transducer may be a thermocouple that detects temperature of the superconductor branch.

The invention also provides a method of stabilizing electric power, including detecting a fault in a grid using a first variable impedance device, inserting a current limiting impedance in a first path of the grid using the first variable impedance device near the fault, transmitting a signal from the first variable impedance device to a second variable impedance device following detection of the fault, receiving the signal at the second variable impedance device and inserting a current limiting impedance in a second path of the grid using the second variable impedance device in response to receiving the signal.

The invention further provides an interactive grid device including first and second terminals, a superconductor component electrically connecting the first and second terminals, a cooling system, the superconductor component being connected to the cooling system to be cooled to below a critical temperature of superconductor material of the superconductor component to allow for superconducting current to flow through the superconductor component, a fault causing decrease in the superconducting current, a state detection transducer positioned to change a detection state when the fault occurs and an integral communications system connected to the state detection transducer, the integral communications system generating and transmitting a signal when the fault occurs.

In the interactive grid device, the state detection transducer may be a thermocouple that detects temperature of the superconductor branch.

In the interactive grid device, the variable impedance device may include a superconductor branch and a finite impedance shunt branch in parallel, current passing through the superconductor branch if the current is below a critical current of the superconductor branch, and the current through the superconductor branch being reduced by the superconductor branch if the current exceeds the critical current and being increased in the finite impedance branch, to increase an impedance of the superconductor branch and the finite impedance branch in parallel.

The interactive grid device may further include an element that is operable to couple and decouple from the superconductor material of the superconductor branch, a change in coupling causing a change in resistance of the superconductor branch, the element being connected to the integral communications system so that the integral communications system operates the element in response to reception of the signal.

In the interactive grid device, the element may be a solenoid element that creates a magnetic field in the superconductor branch when energized.

### BRIEF DESCRIPTION OF THE DRAWINGS

The invention is described by way of examples with reference to the accompanying drawings, wherein:

FIG. 1 is a diagram of an electric grid including a plurality of connected electric paths and an electric grid stabilization metadevice made of a plurality of integrated grid devices IGDs;

FIG. 2 is a view similar to FIG. 1 after a fault has occurred in one of the electric paths to trigger one of the IGDs;

FIG. 3 is a view similar to FIG. 2 after a plurality of the IGDs are triggered;

FIG. 4 is a view similar to FIG. 1 after a fault has occurred in another path to trigger another IGD;

FIG. 5 is a view similar to FIG. 4 after a plurality of the IGDs are triggered;

FIG. 6 is a view similar to FIG. 1 after a fault has occurred in a further path to trigger a further IGD;

FIG. 7 is a view similar to FIG. 6 after a plurality of the IGDs are triggered;

FIG. 8 is a schematic view of an operation system structure;

FIG. 9 is a diagram illustrating one of the IGDs in further detail;

FIGS. 10A and 10B are graphs illustrating switching speeds of various materials;

FIG. 10C is a graph showing Quench Propagation Velocity (QPV) for the different materials;

FIGS. 11A to 11C are graphs illustrating switching speeds of various materials;

FIG. 12 is a perspective view illustrating current limiting aspects of the IGD;

FIG. 13 is a perspective view illustrating placement of thermocouples for fault detection;

FIG. 14 is a perspective view illustrating aspects that allow for the impedance of the IGD to be controlled actively as well as passively;

FIGS. 15A and 15b are perspective views illustrating aspects relating to integral communication capabilities of the IGD;

FIG. 16 is a diagram illustrating a radial distribution network forming part of a prior art;

FIG. 17 illustrates a “re-closing” schedule of the network of FIG. 16;

FIG. 18 is a view similar to FIG. 16 wherein breakers of FIG. 16 have been replaced with FCLs, according to the prior art;

FIG. 19A shows a trigger sequence of an FCL device; and

FIG. 19B illustrates the insertion of a current limiting impedance by the FCL.

### DETAILED DESCRIPTION OF THE INVENTION

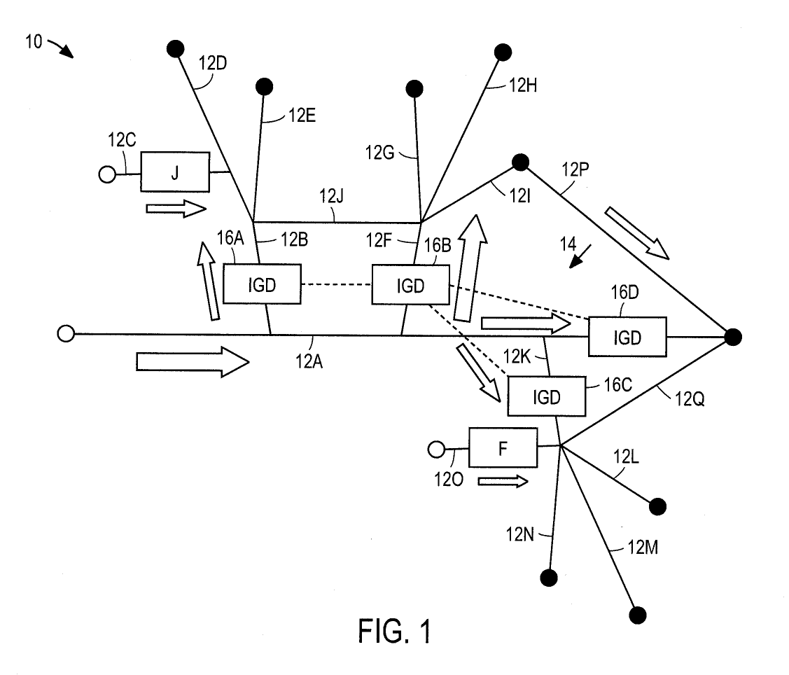

FIG. 1 of the accompanying drawings illustrates an electric grid 10 including a plurality of connected electric paths 12A-G and an electric grid stabilization metadevice 14.

The electric grid stabilization metadevice 14 includes a plurality of IGDs 16A-16D. The IGDs 16A-16D are located within the electric paths 12B, 12F, 12K and 12A, respectively. The IGD 16A has the ability to switch between a mode wherein superconductor current passes through the IGD 16A and a mode wherein the IGD 16A inserts a current limiting impedance into the electric path 12B while still allowing current to flow through the electric path 12B. The IGD 16A can passively detect a fault downstream of the electric path 12B, for example in the path 12D and switch from the mode wherein superconductor current is carried through the IGD 16A and the mode wherein the IGD 16A inserts a current limiting impedance in the electric path 12B.

The IGD 16A also has transmission and reception capabilities. When a fault is detected by the IGD 16A, the IGD 16A can transmit a signal to the other IGDs 16B-16D. When receiving a signal from another IGD 16B-16D at the IGD 16A, the IGD 16A can respond to the signal and actively, but automatically switch from the mode wherein superconductor current is carried through the IGD 16A to the mode wherein the IGD 16A inserts a current limiting impedance in the electric path 12B.

The IGDs 16A-16D are identical. As such, the IGD 16B can switch between a mode wherein superconductor current is carried through the IGD 16B and a mode wherein the IGD 16B inserts a current limiting impedance in the electric path 12F. The IGD 16B can passively detect a fault, insert a current limiting impedance in the electric path 12F, and simultaneously transmit a signal or signals to the IGDs 16A, 16C and 16D when the fault is detected. Alternatively, the IGD 16B can respond to a signal received from any one of the IGDs 16A, 16C or 16D and actively insert the current limiting impedance in the electric path 12F in response to receiving the signal. The IGDs 16A-16D of the metadevice 14 can thus all communicate with each other.

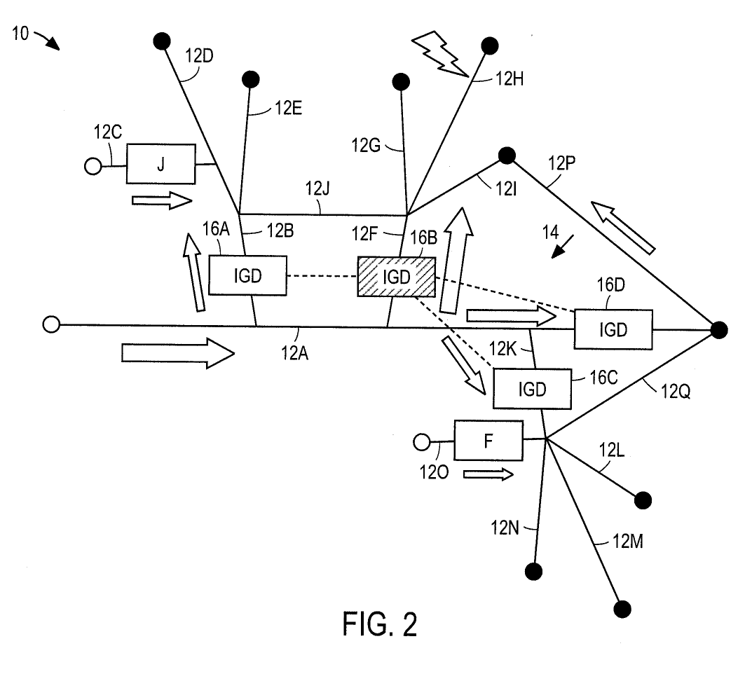

FIG. 2 illustrates a fault that occurs downstream of the IGD 16B, at which time two events occur in quick succession. First, the IGD 16B quickly inserts a current limiting impedance into the electric path 12F as shown by the cross-hatching of the IGD 16B. Next, the IGD 16B automatically transmits a signal to the appropriate nearest neighbor IGDs 16A, 16C and 16D that the fault has occurred.

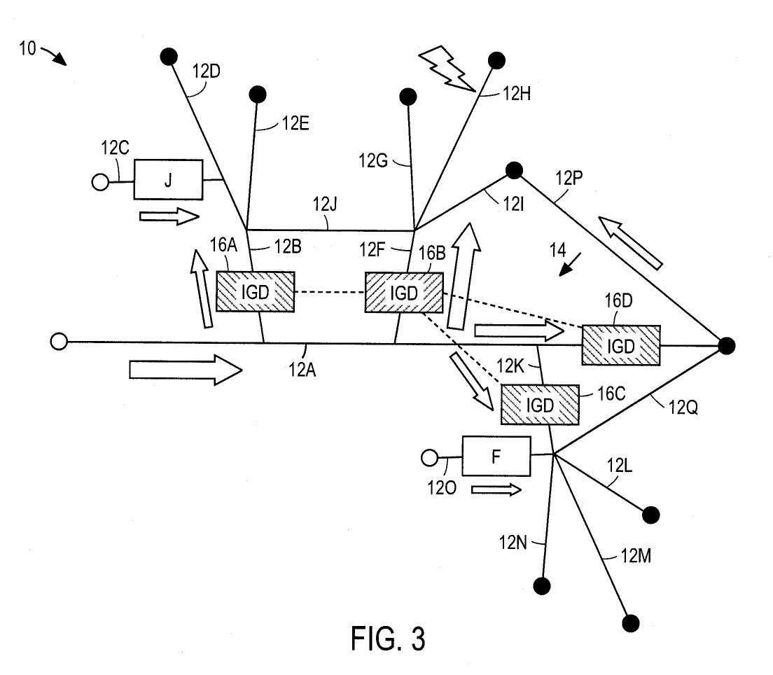

As shown in FIG. 3, the IGDs 16A, 16C and 16D automatically and preemptively insert an impedance in the respective electric paths 12B, 12K and 12A as illustrated by the cross-hatching of the IGDs 16A, 16C and 16D. The fault energy is thus absorbed in a distributed manner through the coordinated cooperation of the individual IGDs 16A-16D. As illustrated when comparing FIG. 1 to FIG. 3, there is only a minor redistribution of the flow of power during the fault event because impedance is inserted in several places within the electric grid 10. By limiting the fault current in this manner, and minimizing the renormalization of power flow in the electric grid 10 through the use of coordinated current limiting devices (the IGDs 16A-16D), the overall stability of the electric grid 10 is substantially improved. In particular, the flow of power in the grid utilizing the metadevice 14 is vastly different than that of the same grid having re-closing circuit breakers because of the characteristic feature of the IGDs 16A-16D that allow for the continued flow of current in transient fault conditions. In permanent fault conditions, the IGDs 16A-16D will eventually “open” in a lock-out state that will serve to sectionalize the damaged portion of the electric grid 10.

In a larger system, a fault detected by a first IGD causes insertion of the current limiting impedance by a second IGD without causing insertion of a current limiting impedance by a third IGD. The second IGD is nearer to the first IGD than the third IGD. The third IGD will only insert an impedance if an intrinsic fault is detected by the second IGD and there would be a time delay between the insertion of the current limiting impedance by the second IGD and the insertion of the current limiting impedance by the third IGD. There may also be more than one “nearest” neighbor. The “nearest” neighbors are determined by the circuit topology and not geography. Neighbors are always connected to the IGD that first trips by a current path with no intervening IGD between them. This can be set in a program by power engineers or can be determined by the device upon installation through a “ping”-like procedure over the power lines. As in the example of FIGS. 1 to 3, a first group of IGDs can be programmed to be “nearest” devices and trip simultaneously. A second group of devices can be programmed not to be “nearest” devices, and would thus not trip together with the first group of devices. One or more of the devices of the second group would only trip if an intrinsic fault is detected by one of the devices of the first group excluding the device that caused the first group of devices to trip.

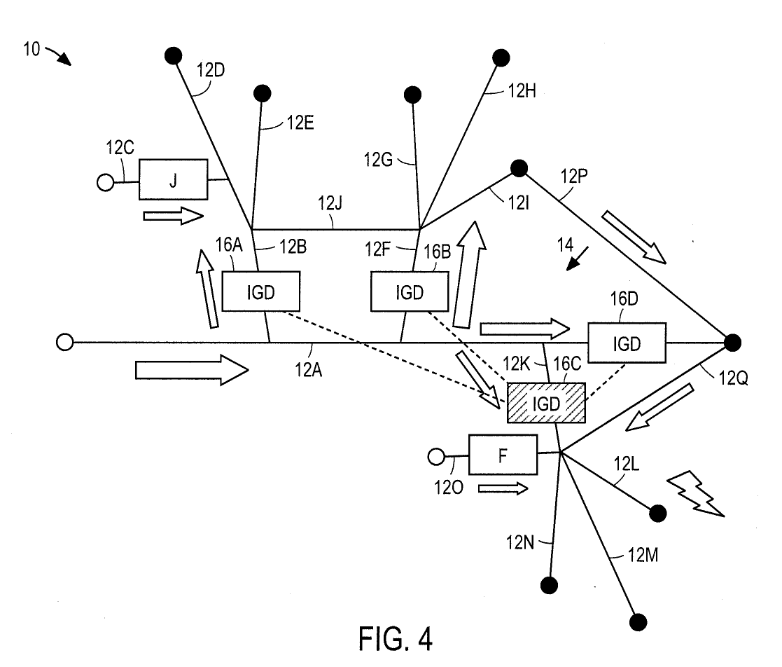

FIG. 4 illustrates a fault that occurs downstream of the IGD 16C, at which time two events occur in quick succession. First, the IGD 16C quickly inserts a current limiting impedance into the electric path 12K as shown by the cross-hatching of the IGD 16C. Next, the IGD 16C automatically transmits a signal to the appropriate nearest neighbor IGDs 16A, 16B or 16D that the fault has occurred.

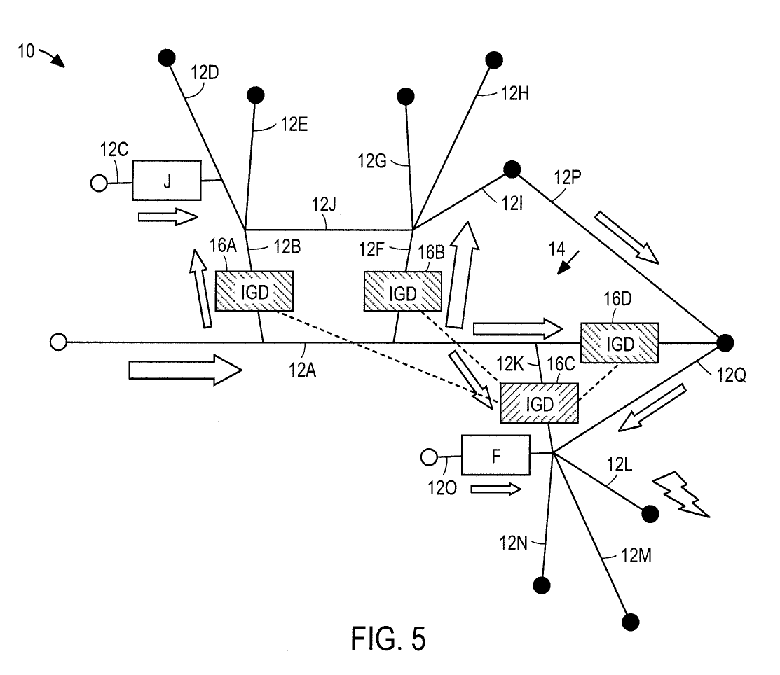

As shown in FIG. 5, the IGDs 16A, 16B and 16D automatically and preemptively insert an impedance in the respective lines 12B, 12F and 12A as illustrated by the cross-hatching of the IGDs 16A, 16B and 16D. The fault energy is thus absorbed in a distributed manner through the coordinated cooperation of the individual IGDs 16A-16D. As illustrated when comparing FIG. 1 to FIG. 5, there is only a minor redistribution of the flow of power during the fault event because impedance is inserted in several places within the electric grid 10.

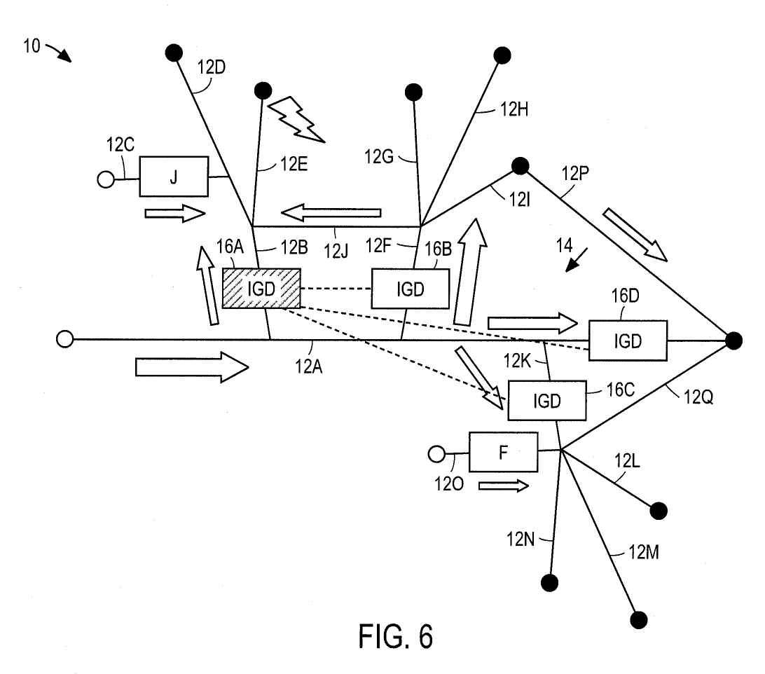

FIG. 6 illustrates a fault that occurs downstream of the IGD 16A, at which time two events occur in quick succession. First, the IGD 16A quickly inserts a current limiting impedance into the electric path 12B as shown by the cross-hatching of the IGD 16A. Next, the IGD 16A automatically transmits a signal to the appropriate nearest neighbor IGDs 16B, 16C or 16D that the fault has occurred.

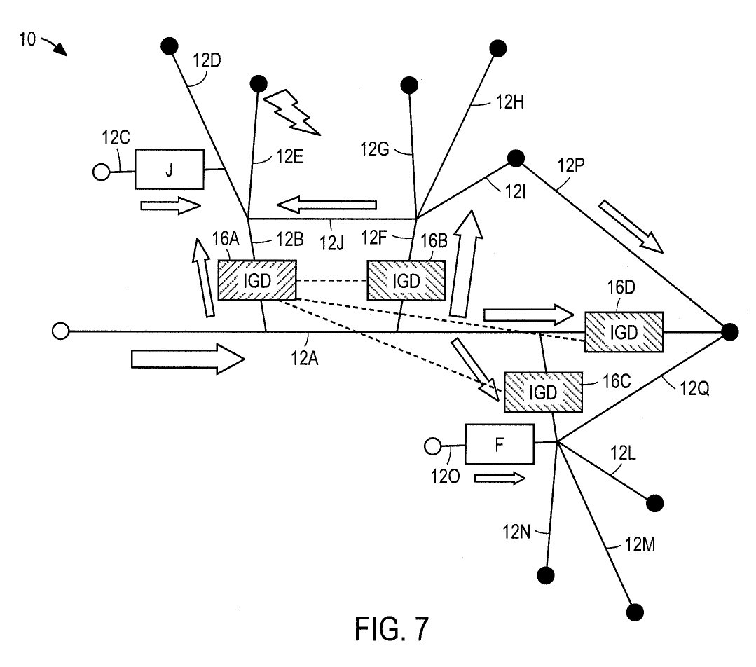

As shown in FIG. 7, the IGDs 16B, 16C and 16D automatically and preemptively insert an impedance in the respective lines 12F, 12K and 12A as illustrated by the cross-hatching of the IGDs 16B, 16C and 16D. The fault energy is thus absorbed in a distributed manner through the coordinated cooperation of the individual IGDs 16A-16D. As illustrated when comparing FIG. 1 to FIG. 7, there is only a minor redistribution of the flow of power during the fault event because impedance is inserted in several places within the electric grid 10.

The previous illustrations demonstrates the unique properties of the interconnected IGDs 16A, 16B, 16C and 16D. The IGDS 16A, 16B, 16C and 16D respond passively to transient high current surges in the electric grid 10, and actively based on the state of neighboring IGDs 16A, 16B, 16C and 16D. Local and non-local behavior serve to detect and attenuate fault currents and protect downstream equipment from damage. Furthermore, by preventing re-closing breakers from triggering, an IGD with local control also serves to improve downstream power quality by allowing power to flow in a controlled manner during transient fault currents.

By linking the IGDs 16A, 16B, 16C and 16D together, it is possible to create a new, distributed device on the electric grid 10. This device responds to a fault triggered by an IGD 16A, 16B, 16C or 16D to stabilize the electric grid 10 over many nodes. Borrowing from computer science, a group of IGDs can be thought of as a metadevice 14; that is a logical device that encompasses a group of physical devices. The metadevice 14 possesses very simple logic states that can, in principle, lead to very sophisticated behavior. A partial list of logical states of the metadevice 14 is shown below:

| Metadevice State | Comment |
|---|---|
| Superconducting A | Normal load conditions |
| Superconducting B | Increased load, multiple elements |
| Normal A | Fault event |
| Normal B | Thermal recovery under load |
| Normal C | Thermal recovery under no load |
| Normal D | Active trigger from neighbor fault |
| Normal E | Variable impedance, multiple elements |

The metadevice 14 may be located within the same substation, or located at far-reaching substations and nodes on the network. In addition, while the discussion has focused on the interconnection of similar IGDs 16A-16D, it is also possible to create a utility grid metadevice with dissimilar devices. For example, an interconnected group of IGDs, FCLs, breakers, and switchgear can also be considered a metadevice as long as the discrete physical devices are connected (i.e. communicating) and interacting with other members of the group.

Through precise geographical location of the distributed IGDs and a high precision clock, it is also possible to use the metadevice state functions to gain information about the status of the electric grid, such as line congestion, peak load, fault location, and damage isolation.

### Potential Devices for Use in a Utility Grid Metadevice

A partial list of potential devices for use in a utility grid metadevice is shown below. For a physical device to qualify for use in a logical metadevice, the physical device must be able to control some property of the electric grid (e.g. voltage level, power flow, current level, phase, etc.) and be able to communicate this information to other members of the group, which can thus act in a specific manner in response. In this way, the behavior of the metadevice depends in detail on the specific logical, state of each physical device in the group.

Partial List of Physical Devices that could be Used in a Utility Metadevice
1) Smart Grid transducer: monitoring power flow to end users (demand/response)
2) FCL: transient fault detector and attenuator.
3) Variable Impedance Device equipped with Integral Communication Capabilities (VIDICC): non-local fault response, active load management
4) Breaker: permanent fault isolation, disruptive power flow management
5) Reactive Power Compensator: voltage regulation and stability

The two basic parts of an IGD may be:
Grid Circuit Elements—the part of the device that is in the grid circuit
   Superconductor metal matrix composite (SMMC) element
   Switchgear in a Breaker
   Current transducer in a Smart Grid monitor
Device Control Electronics—the active control and communications portion of the device.
   The control electronics are isolated from the grid circuit element (e.g. the control electronics may be optically coupled, or coupled by other means that shield the device control electronics from the grid circuit elements).
   Control electronics change the state of the IGD and thus provide device behavior. (e.g. apply current to solenoids surrounding the SMMC elements to change their state).
   Control electronics mimic behavior of the circuit elements necessary communicate with other IGDs.
   Control electronics includes a Global Positioning Satellite (GPS) or equivalent transducer that provides position and time information.
   The control electronics uniquely identifies the IGD through its position and intrinsic logic states.
   IGDs communicate directly with other IGDs and with the Network Management System (NMS)
   The control electronics is powered by an independent, dedicated power source (e.g. solar cell with a battery backup, etc.)

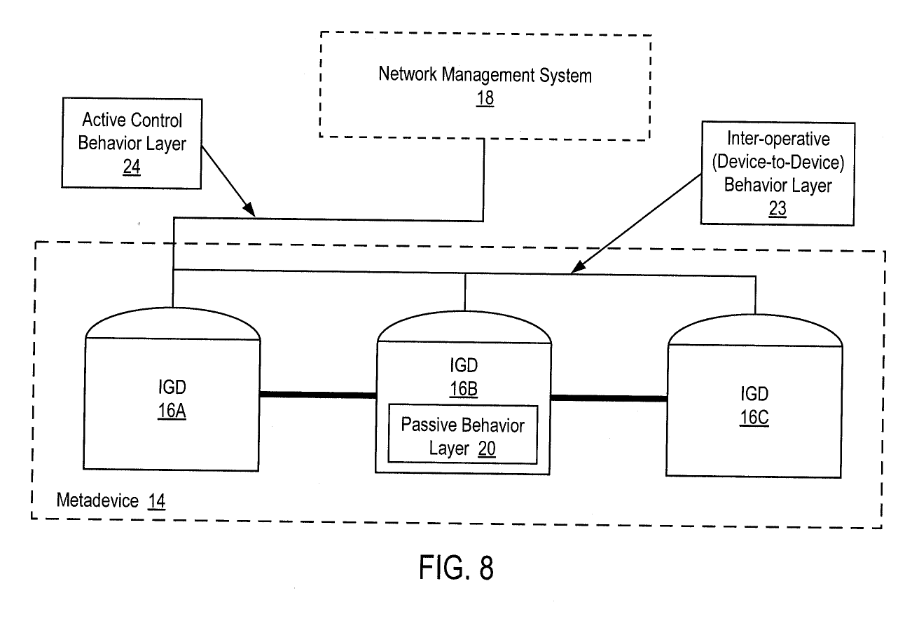

IGDs have three modes of behavior, which include the passive, intrinsic behavior of the device, the control electronics layer behavior that is driven by the IGD interaction with other physical IGDs of the metadevice, and a high-level controlled behavior that is driven by a network management system (NMS) 18. A schematic of the operational system structure is shown in FIG. 8.

### Passive Behavior Layer 20

This layer consists of the physical devices in the power distribution network. Each device possesses specific logical states, and can affect the power distribution network in some manner. Individual devices communicate with other devices in the metadevice 14. IGDs 16A, 16B or 16C perform basic functions in the electric grid, such as:
Switch power on/off) or re-route to a separate circuit
Detect, attenuate, and dissipate energy of a transient fault
Regulate power flow
Regulate voltage and reactive power

All IGDs in the passive behavior layer 20 possess local intelligence that determines the logical state of the device when operating independently of other devices.

### Inter-Operative Behavior Layer (Device-to-Device) 23

IGDs are interconnected in the inter-operative behavior layer 23 via communication between the control electronics modules to provide device-to-device interaction that determines the behavior of the metadevice. The advantages of interconnection using the control electronics to interconnect devices are that:
The control electronics function and operation is designed to be independent on the operation of the IGD 16A, 16B or 16C or power distribution system. Therefore, information about the status of the IGD 16A, 16B or 16C and power distribution system can be transmitted even if physical IGDs 16A, 16B or 16C fail.
In the event of a catastrophic failure of an IGD 16A, 16B or 16C, neighboring control electronics modules can detect the absence of the failed IGD 16A, 16B or 16C, and the associated device-to-device interaction, and report this information to the NMS 18.
Control electronics can simultaneously pass information to the NMS 18 active management layer for event logging and active control.

IGD communication is critical to the operation and behavior of the metadevice. This communication may be achieved by a number of means, such as:

Wireless Communication
Radio signal is sent to all devices but only the IGD that has the permission to receive the message acts on the signal. This means that the control electronics modules would have to have the ability to store naming information about the devices to which it connects. Different radio frequencies can be used independently or simultaneously to control the IGDs 16A, 16B or 16C.

Wired Communication
If the IGDs 16A, 16B or 16C of the metadevice 14 are networked together via direct connections, individual IGDs 16A, 16B or 16C could pass information between neighbors until they find the destination. This information exchange process would be similar to an Internet Protocol (IP) network and would take advantage of IP technology. This form of communication may have a presence on the world wide web, but for security reasons may operate as an isolated intranet.

Combination of Wireless and Wired Communication
Physical separation distance and IGD 16A, 16B or 16C response time may determine the ultimate form of communication between physical devices in the metadevice. Transient faults, for example, require very fast communication/response from neighboring IGDs 16A, 16B or 16C. Thus, IP communication may not be adequate when responding to short time scale disturbances and radio methods should be employed.
Demand/response and line congestion issues, however, tend to occur on much longer timescales, and thus IP communication will suffice for these events. Also, a combination of communication methods (e.g. radio signal sent after transient fault event, with confirmation of neighboring IGD 16A, 16B or 16C activation via IP) may be used to add security and robustness to the overall operation of the metadevice.

In all forms of IGD communication within the metadevice, encryption methods such as the data encryption standard or advanced encryption standard (AES) must be used for device-to-device communication and for metadevice communication to the NMS 18. Such methods are well known to those in the art.

### Active Control Behavior (Network Management System) 24

The IGDs 16A, 16B or 16C and associated metadevices communicate with a NMS via a secure, encrypted communication link in the control electronics. The NMS 18 has access to all IGDs 16A, 16B or 16C within a metadevice, and all metadevices 14 on the power distribution network. In principle, the NMS 18 may allow for the creation of a “super”-metadevices that is a collection of two or more metadevices.

The communication with IGDs 16A, 16B or 16C and metadevices may include:
IGD device identifier
Time stamp
IGD logical state
Metadevice state
Grid status information (fault occurrences, configuration management, power flow, etc.)
Encryption key synchronization (two sided)
Active commands to individual IGDs 16A, 16B or 16C or metadevices 14

The NMS 18 provides for the overall control of a power distribution system. The NMS 18 has the authority to override any metadevice 14 or IGD 16A, 16B or 16C on the system with the purpose of maintaining power flow and grid stability. The automated, “intelligent” response of the power distribution system is contained within the behavior of the metadevices, which the NMS 18 controls. Some possible functions of the NMS 18 include:
Fault management
Configuration management
Security management
Maintenance management
Accounting management
Capacity Planning/Grid Performance Management

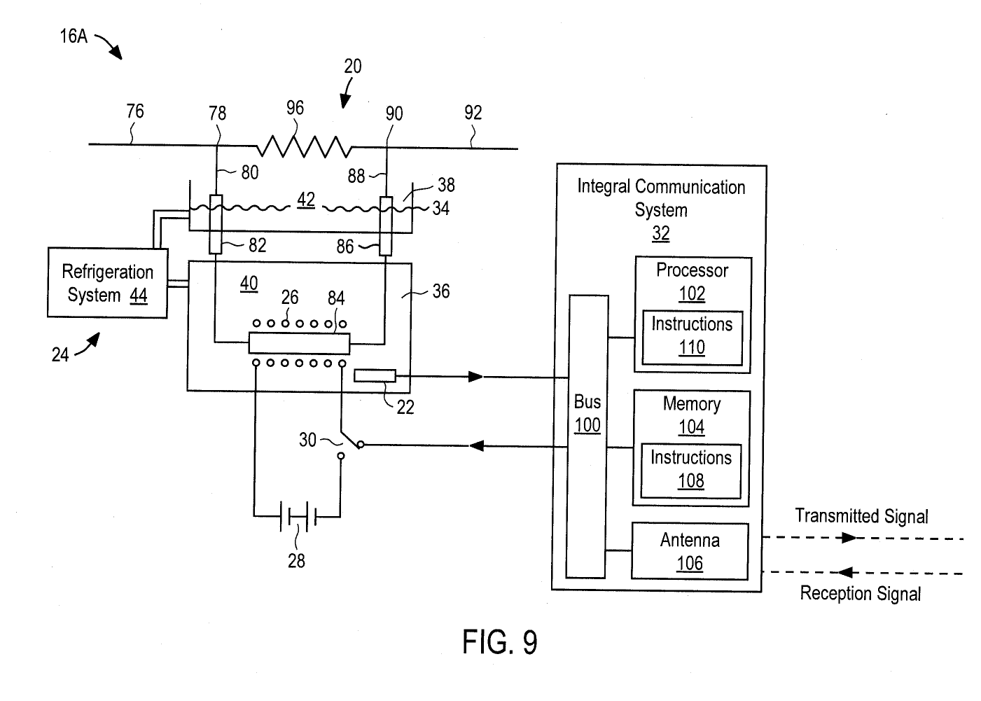

FIG. 9 illustrates the IGD 16A of FIG. 1 in more detail. The IGD 16A includes a variable impedance device 20, a thermocouple 22 acting as a state detection transducer, a cryogenic cooling system 24, a solenoid element 26, a battery 28, a switch 30 and integral communication system 32.

The cryogenic cooling system 24 includes an enclosure in the form of a cryogen tank 34 having lower and upper regions 36 and 38, respectively, hydrogen vapor 40 (or another cryogenic medium such as liquid neon) in the lower region 36, and at about 20K (or alternatively, helium vapor at any temperature above 4.2K, or hydrogen liquid at 20K, or neon vapor above 27K, or neon liquid at 27K), and liquid nitrogen 42 in the upper region 38 at between 66K and 77K, and a refrigeration system 44 to maintain the hydrogen vapor 40 and the liquid nitrogen 42 at their respective temperatures.

The variable impedance device 20 includes a power cable 76, a terminal 78, a current section 80, an HTS section 82, an MgB₂-based SMMC FCL superconductor branch 84, an HTS superconductor section 86, a current section 88, a terminal 90, and a power cable 92 sequentially in series after one another. The terminals 78 and 90 are located outside the cryogen tank 34. The current sections 80 and 88 extend into the top of the cryogen tank 34. An interface between each current section 80 or 88 and a respective HTS section 82 or 86 is located within the liquid nitrogen 42. Lower ends of the HTS superconductor sections 82 and 86, together with the MgB₂-based SMMC FCL superconducting branch 84 are located in the hydrogen vapor 40.

The variable impedance device 20 also includes a finite impedance shunt branch 96 in parallel with the FCL superconducting branch 84 and connected to the terminals 78 and 90.

In this design, current flows into and out of the variable impedance device 20 through hybrid high-current leads comprised of a copper section of the current section 80 and an HTS ceramic section of the HTS superconductor section 82. The copper of the current section 80 may be liquid or vapor-cooled, and it is optimized in cross-sectional area to minimize the heat leak to the refrigeration stage cooled at approximately 77K. At the 77K stage, the copper current section 80 is attached, via a low resistivity joint, to the bulk ceramic HTS section 82. The HTS section 82 may be in the form of a bar, tube, cylinder, plate, etc. The HTS section 82 is designed to have a very low thermal conductivity, thus there preferably should not be any metallic resistive shunt branch 96 connecting the copper section 80 to the low-temperature lower region 36 of the variable impedance device 20. The HTS section 82 terminates in the low-temperature lower region 36 of the variable impedance device 20, where it connects to the MgB₂-based SMMC FCL superconducting branch 84 with a very low resistivity contact. Preferably, the contact between the HTS section 82 and the MgB₂-based SMMC FCL superconducting branch 84 is a fully superconducting contact.

The FCL superconducting branch 84 consists of an MgB₂-based SMMC component in parallel with a current limiting resistive shunt branch 96. After passing through the FCL superconductor branch 84, the current then passes through the HTS section 86, the copper current section 88, and passes out of the IGD 16A.

Details of FCLs and SMMCs are described in U.S. patent application Ser. No. 11/259,988 entitled “FAULT CURRENT LIMITING SYSTEM,” filed on Oct. 26, 2005 claiming priority from U.S. Provisional Patent Application No. 60/622,476, filed on Oct. 26, 2004; U.S. Provisional Patent Application No. 60/629,079, filed on Nov. 18, 2004; U.S. Provisional Patent Application No. 60/637,176, filed on Dec. 17, 2004; and U.S. Provisional Patent Application No. 60/703,660, filed on Jul. 29, 2005, all of which are incorporated herein by reference.

For currents less than the critical current of the FCL superconductor branch 84, the current passes through the copper current sections 80 and 88, and the fully superconducting HTS sections 82 and 86, and the fully superconducting MgB₂-based SMMC FCL superconducting branch 84. In a fault current condition, the current passes through the copper current sections 80 and 88, and through the HTS sections 82 and 86. The majority of the fault current then passes through the current limiting finite impedance shunt branch 96. This finite impedance shunt branch 96 adds additional impedance to the power grid and attenuates the magnitude of the fault current. In this example, the fault current passes through the HTS sections 82 and 86. Thus, it is important to design the HTS sections 82 and 86 such that the possible fault currents in the particular system do not exceed the critical current of the HTS sections 82 and 86. If the fault current exceeds the critical current (I_{C}) of the HTS components, it could lead to the catastrophic failure of the variable impedance device 20.

The shunt consists of a finite impedance element in this example, which could be inductive, resistive or a combination of both resistive and inductive. While the superconducting branch is necessarily cooled to a temperature below the critical temperature (T_{C}) of the superconductor, the current limiting shunt may be located within or outside of the cryogenic environment. Current transport through the circuit is determined by the resistance of the superconducting branch (Z_{SC}), which is a function of the critical current of the superconductor. For currents less than I_{C}, the superconductor has essentially zero resistance and all of the current passes through the superconducting branch of the circuit. This is the standard operating mode of the FCL when there are no fault events. In this case, the FCL simply passes the current through the superconducting branch 84 and does not impose an additional load on the electrical distribution system; the operation of the FCL is transparent to the power distribution network in the absence of fault events, adding minimal operating costs and requiring no other system modifications.

With the onset of a fault, the current through the superconducting branch exceeds I_{C}, and the resistance of the superconductor rapidly changes from zero to Ω_{N}. Because the circuit is designed such that ΩN>>Z_{Shunt}, this rapid increase in the resistance of the superconducting branch redirects the majority of the fault current through the shunt branch of the circuit. Overall, the impedance of the equivalent FCL circuit shown in FIG. 1 changes from zero for currents less than I_{C}, to Z_{Shunt} for currents greater than I_{C}. The fast insertion of this impedance during the onset of a fault serves to reduce the magnitude of the fault event and thus prevent downstream breakers from tripping in the event of a transient fault. The majority of the fault energy in this FCL design is dissipated in the shunt branch.

After the fault event, the current returns to a value below I_{C} and the resistance of the superconducting branch returns to zero. This decrease in resistance of the superconductor, for currents less than I_{C}, once again redirects the current flow such that all current is carried by the superconducting branch. This is the passive automatic reset of the FCL circuit that is unique to the operation of a superconducting FCL. In these devices, the fault current detection and attenuation result from an electronic phase transition (i.e. the superconducting- to normal-state transition) that is triggered by the magnitude of the current flowing through the superconducting component. Unlike other fault current detection schemes, superconducting FCLs do not require any sophisticated fault current detection algorithms to determine if a fault event is occurring. Rather, the fault detection and the system response are intrinsic. This is one of the primary advantages of the superconducting FCL.

The circuit responses can be expressed as follows:

Superconducting Branch

Z_{SC}=0;I<I_{C}

Z_{SC}=ΩN;I>I_{C}

Shunt Branch

Z_{Shunt}=Ω_{Shunt}+ωΩL_{Shunt}

Equivalent Circuit Impedance

Assume ΩN>>Z_{Shunt}

Z_{FCL}=0;I<I_{C}

Z_{FCL}˜Z_{Shunt};I>I_{C}

The circuit behavior described above, and the very high power levels encountered during fault events, clearly impose severe requirements on the properties of the superconducting components used to fabricate the FCL. In general, the superconducting component must possess the following properties to be used effectively in a fault current limiting application;
I. The component must remain stable and fully superconducting for all currents less than I_{C}
II. The component must exhibit low AC loss for normal load currents
III. The component must rapidly revert to a normal-state when the transport current exceeds I_{C}
IV. The component must have a high normal state resistance (N when the transport current exceeds I_{C}
V. The component must recover quickly from the temperature rise encountered during the superconducting- to the normal-state transition that occurs at the onset of the fault
VI. The superconductor must be able to withstand the repeated thermal and mechanical shocks encountered during the many fault events encountered over the device lifetime with no significant decrease in I_{C}
   In addition to these demanding electronic and mechanical properties, the superconducting component must be inexpensive and easily fabricated into the necessary geometries for use in an economical FCL device.

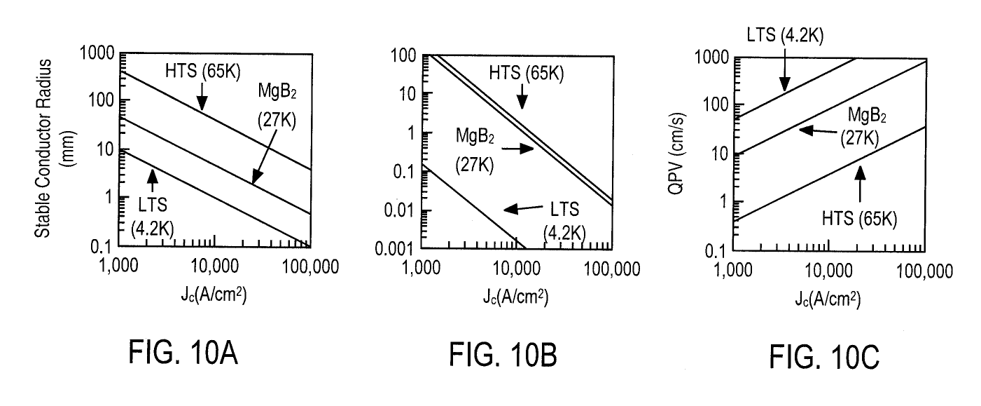

The current carrying stability, AC loss, and switching time of a superconductor (properties I, II, and III above) depend profoundly on the electronic and materials properties of the superconductor. Superconducting materials are able to transport currents in a stable condition if the heat generated from fluctuations (e.g. mechanical, flux flow, thermal, etc.) is removed at a rate greater than it is generated. The adiabatic stability criterion of a superconductor is a measure of the stability of the conductor under current carrying conditions. FIG. 10A shows the maximum radius of a stable superconducting conductor as a function of critical current density (J_{C}) for low-temperature superconductors (LTS), HTS, and MgB₂. These data represent the maximum conductor radius that is able to sustain a stable supercurrent for each class of superconductor as a function of J_{C}. From the graph, it is seen that LTS materials have very low adiabatic stabilities. This is the primary reason high current LTS conductors are typically made from an assembly of very fine superconducting filaments that are stabilized by a copper matrix. MgB₂ and HTS conductors, however, can sustain stable supercurrents up to much larger conductor radii, primarily because of the high specific heat of these materials associated with higher operating temperature.

The situation is complicated under AC load conditions because the changing magnetic field at the superconductor surface causes power loss due to both hysteretic and eddy current effects. In Type II superconductors, for self-fields greater than H_{CI}, magnetic flux penetrates the material and these flux lines move in response to the time varying magnetic field. This movement results in hysteretic dissipation, which is proportional to frequency. If the superconducting material is adjacent to a normal metal, as is the case with many LTS, HTS, and MgB₂ conductors in wire or tape geometries, then the oscillating magnetic field generates resistive eddy current loss in the normal metal layer that is proportional to the square of the oscillation frequency. In high power AC applications, these two loss components determine the minimum steady-state cryogenic requirements, and thus the engineering and economic viability of the device.

The following table contains recent AC loss data for a number of conductors and puts into context the critical importance of AC loss in the design of economical superconducting power applications. Total AC loss figures are difficult to normalize among the various groups and so these data include the measurement temperatures, frequencies, and peak current amplitudes relative to the DC critical current (I/I_{C}), if available.

| Conductor | AC Loss | Conditions |
|---|---|---|
| HTS 2G tape “coated | ~0.1 W/m | 77K, sf, 51 Hz, 100A_{P}, I/Ic ~0.6 |
| conductor” | | |
| HTS 1G tape “Powder- | ~0.1 W/m | 77K, sf, 60 Hz, 96A_{P}, I/Ic ~0.8 |
| in-Tube” | | |
| MgB₂ wire “Powder-in- | ~1.0 W/m | 4.2K, sf, 60 Hz, 480A_{P}, I/Ic ~ |
| Tube” | | |
| HTS Bifilar Coil “Melt | ~0.1 W/cm³ | 65K, sf, 50 Hz, 400A_{RMS} |
| Cast Ceramic” | | |

These data indicate that HTS and MgB₂ wire conductors exhibit large AC loss under relatively small AC loads. Note that a normal-load condition for distribution-level FCL devices is generally in excess of 600 A_{RMS} (i.e. ˜850 A_{P}); much larger than the measurement conditions listed in the table above. In addition, typical large-scale power applications may require many kilometers of conductor. The combination of high AC loads and long conductor lengths suggest many kilowatts of refrigeration capacity will be needed to maintain the operating temperature of the device. While superconducting component geometries (e.g. twisted filaments, filament transposition, non-inductive configurations, etc.) that shield the material from time varying magnetic fields may significantly reduce the total heat load, ultimately, the transport AC loss in both HTS and MgB₂ conductors determines the cryogenic requirements, and the economic viability, of large-scale superconducting devices.

In addition to remaining stable under normal-load conditions, it is equally important that the superconducting material switch rapidly to the normal-state when the load current exceeds I_{C}. FIG. 10B shows the switching time of LTS, MgB₂, and HTS materials, which, similar to the adiabatic stability, is also intimately connected to the specific heat of the material. It is seen in the figure that the switching time of LTS materials is nearly 1000 times faster than both the MgB₂ and HTS materials. In this case, however, it is the large specific heat of HTS and MgB₂ that dramatically slows the response time of the material. In other words, for currents greater than I_{C}, a high specific heat material will take more time to heat to a temperature greater than T_{C} than a low specific heat material. These results suggest that a balance between adiabatic stability and switching time must be reached to achieve optimum performance in a FCL application. Because these properties are determined largely by intrinsic properties of the material, a proper balance may be difficult to achieve in pure LTS, HTS, or MgB₂ wire FCL designs.

As the current through a superconductor exceeds I_{C}, non-superconducting islands tend to form at a number of locations within the material. These localized normal regions within the superconductor then propagate throughout the material during the quench (i.e. the rapid transition from the superconducting to the normal metallic state). The rate of the propagation of this non-superconducting zone is known as the Quench Propagation Velocity (QPV) and is shown in FIG. 10C for LTS, HTS, and MgB₂. Again, LTS materials have very high QPVs, which suggest that when LTS materials undergo a quench, it moves very quickly throughout the LTS component. HTS materials, however, because of the inherently low thermal conductivity of the materials and the relatively large specific heat at higher temperature, suffer from QPVs nearly 100 times slower than LTS materials. Thus, when the current exceeds I_{C}, HTS materials tend to quench at localized “hot spots” which do not propagate quickly through the component. Because of this, HTS materials are susceptible to catastrophic thermal runaway in FCL applications if the heat generated during the fault condition is not effectively managed. Such events can permanently damage the HTS materials in the FCL, rendering the system useless.

Adiabatic stability, AC loss, switching time, and QPV of a superconducting material are important factors in the design of superconducting FCL devices. These factors are intrinsic to the specific superconducting material used in the superconducting branch of the FCL. The characteristics described in properties IV, V, and VI, however, relate specifically to the engineering properties of the superconducting component used in the FCL. Of particular importance is the design of a superconducting component with a high resistance, Ω_{N}, upon reverting to the normal state.

The critical current of a superconducting conductor is a function of the physical geometry of the conductor and the materials critical current density (J_{C}). Specifically,

I_{C}(Amps)=J_{C}(Amps/cm²)Θ(cm²),

where Θ is the cross-sectional area of the conductor. The critical current density of a superconductor is intimately tied to the specific materials preparation method, and is limited ultimately by the intrinsic properties of the superconducting state and the extrinsic geometry-dependent self-field. With a given material J_{C}, the critical current of a superconducting conductor is most easily engineered by adjusting the cross-sectional area of the component, this area being limited by the adiabatic stability criterion. Referring to FIG. 1, recall that efficient operation of the FCL requires that ΩN>>Z_{Shunt} for currents much greater than I_{C}. The resistance of a superconducting conductor for currents greater than I_{C} (i.e. the normal-state resistance of the conductor, Ω_{N}) is given by,

Ω_{N}(Ohms)=Ω_{N}(Ohm cm)l(cm)/Θ(cm²),

where Ω_{N} is the resistivity of the superconductor in the normal metallic state (i.e. for currents greater than I_{C}, temperatures greater than T_{C}, or magnetic fields greater than H_{C}), l is the length of the component and Θ is the cross-sectional area of the component. To achieve a given superconducting I_{C}, the cross-sectional area Θ is fixed, and then Ω_{N} is determined by the normal state resistivity and the length of the component. Similar to J_{C}, Ω_{N} is intimately tied to the specific materials preparation method, and is limited ultimately by the intrinsic properties of the normal metallic state of the superconductor. Thus, the only engineering option available to increase the resistance of the conductor is to increase its length to achieve the required Ω_{N}, which necessarily increases the cryogenic requirements of the overall system due to the AC loss of the conductor.

Clearly, there are many factors that play a critical role in the design of an effective FCL. The success of any design must take advantage of the specific properties of the superconducting material and incorporate both economic and operational benefits to achieve a viable commercial device. LTS materials have been used in several prototype FCLs in the past, and in general, the low operating temperature (4.2K) of these units has precluded widespread market acceptance. With the development of long length “first generation” (1G) HTS tape, “second generation” (2G) HTS coated conductors, and melt-cast processed bulk HTS components, a number of FCL designs have been explored recently by industry. These devices represent some of the best efforts at developing commercial units, but are still plagued by high AC loss, poor quench performance, and the high cost of the HTS components used in the FCL. MgB₂ materials, on the other hand, represent a middle ground between the LTS and HTS materials with respect to switching time, stability, refrigeration cost, and materials cost. Similar to HTS materials, however, MgB₂ is a hard, brittle ceramic material, and may suffer from the same mechanical shortcomings as the HTS ceramics. To date, LTS, HTS, and MgB₂ superconducting materials do not yet possess the physical and economic characteristics necessary to develop economical superconducting FCL systems.

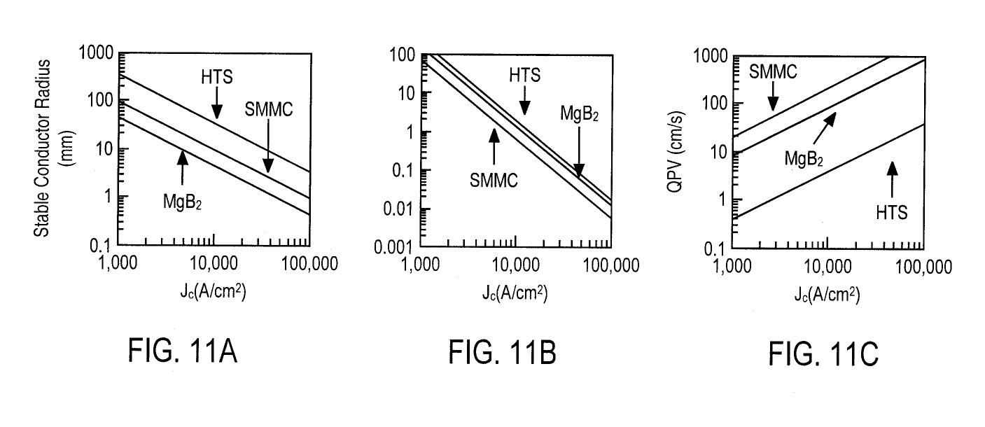

High-performance Superconductor/Metal Matrix Composite (SMMC) materials have been developed using MgB₂ and a variety of metals. With a significantly lower cost than HTS materials, and higher operating temperatures than LTS materials, bulk MgB₂-based SMMC materials are attractive candidates for use in FCL applications operating at temperatures between 20K and 30K. The thermal, electrical, and mechanical properties of these composites are largely determined by the intrinsic properties of the metal matrix, which, at temperatures below the critical temperature of MgB₂, is induced to be superconducting by the proximity effect. Unlike HTS and MgB₂ materials, however, SMMC materials can be engineered (e.g. by varying the metal matrix percent volume and composition) for optimum performance in this demanding application. To illustrate the improved performance of MgB₂/Ga SMMC material versus HTS and MgB₂ ceramics, we have calculated the adiabatic stability, switching time, and quench propagation velocity of these materials at 27K. The results of these calculations, shown in FIG. 11A-11C, are summarized as follows;
The adiabatic stability of a 30% by volume gallium MgB₂/Ga SMMC is approximately twice that of MgB₂ alone
The switching time of MgB₂/Ga SMMC is approximately half that of either MgB₂ or HTS
The QPV of the MgB₂/Ga SMMC is approximately twice that of MgB₂ alone, and nearly fifty times that of HTS

In addition to these superconducting properties, we have measured the normal-state resistivity of a 30% by volume gallium MgB₂/Ga SMMC to be approximately 10 times greater than MgB₂ at 40K and 5 times less than HTS at 100K. As discussed previously, a practical FCL component must not only possess a high critical current, but it must be highly resistive in the normal-state. With a critical current density much greater than HTS, and a normal-state resistivity much greater than MgB₂, MgB₂-based SMMC materials may be ideally suited for use in FCL applications.

By definition, FCLs respond to transient disturbances in the electric utility grid. That is, because of the nature of the transport properties of the superconductor, short timescale current surges are sufficient to trigger the superconducting to normal-state transition result in fault attenuation. The FCL, in essence, acts to both detect and attenuate the current. This behavior is passive, that is, the system does not, in principle, require a separate control system to activate the trigger from the superconducting to the normal state. This transition is driven by the magnitude of current that flows through the superconductor at a given temperature and magnetic field, and is intrinsic to the material itself.

In the FCL shown schematically in FIG. 1 possesses a current limiting shunt in parallel to the superconducting element. This shunt may be a separate component located outside the cryogenic environment, inside the cryogenic environment, or it may be the superconducting component itself when it has been driven to the normal metallic state.

Referring again to FIG. 9, the solenoid 26 is located around the superconducting branch 84 and is connected in series to the battery 28 and the switch 30. The thermocouple 22 is located sufficiently close to the superconducting branch 84 so that the thermocouple 22 can detect an increase in temperature of the superconducting branch 84 when a fault occurs.

The integral communication system 32 includes a bus 100, a processor 102, memory 104 and an antenna 106. The processor 102, memory 104 and antenna 106 are connected to the bus 100. The thermocouple 22 is connected to the bus 100 so that the integral communication system 32 receives a signal from the thermocouple 22. The switch 30 is connected to the bus 100 so that the integral communication system 32 can control the switch 30 to provide power to or switch power off to the solenoid 26. A set of instructions 108 and 110 is located within the memory 104 and the processor 102. Instructions 108 and 110 are executable by the processor 102 to control signals that are transmitted through the antenna 106 and to the switch 30 and to respond to signals received by the antenna 106 and from the thermocouple 22. The state of the metadevice 14 is also recorded in the instructions 108 and 110.

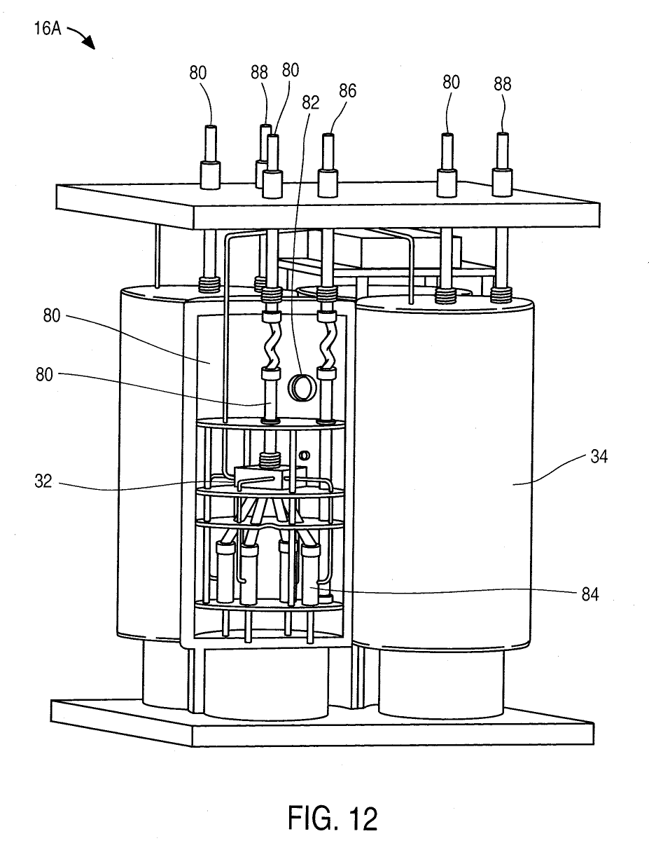

FIG. 12 illustrates a three-phase multi-component current limiting aspects of the IGD 16A. This current limiting system consists of superconducting branches 84 in parallel, which act to both detect and attenuate the fault current. The system is shown with four superconducting branches but any number of superconducting branches may be employed. One phase is shown in detail in the FIG. 12. The current limiting subsystem is housed within the cryogenic environment, which is maintained at a cryogenic temperature below that of the superconducting SMMC current limiting elements of the superconducting branches 84.

The current limiting subsystem is unique in that any number of superconducting branches 84 may carry the load current at any given time. This is controlled by the central control switching system and will allow the device to be triggered at user-defined current levels. For example, if all superconducting branches 84 possess the same critical current, I_{C}, then if the central control switching system 120 is set to pass the load current through a single element, the device will trigger at I_{C}. If the central control switching system 120 is set to pass the current through two elements, the device will trigger at 2I_{C}, and so on. Other triggering current levels may be obtained by fabricating a device with different critical currents for each element. This feature allows for advanced control of the tolerable load levels in a variety of power distribution conditions.

In an example where the normal load current is carried through a single superconducting branch 84, and all elements possess the same critical current, the system is unique in that only one superconducting branch 84 carries the current at a given time. When a fault occurs, the load bearing superconducting branch 84 switches to the resistive normal metallic state, attenuates the current surge (through the seamless insertion of the normal state impedance), and heats rapidly. Each element in the system is equipped with state detection transducers such as a thermocouple 22, for example.

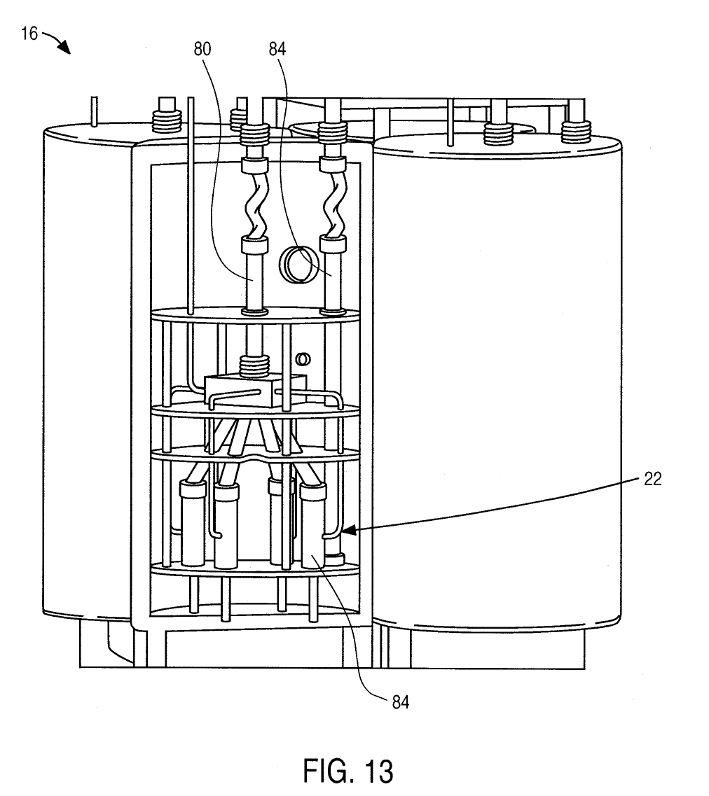

The placement of the thermocouples 22 is shown schematically in FIG. 13. When the thermocouple attached to the superconducting branch 84 detects the associated temperature increase, it triggers the central switch control system 120 to switch off the current through the faulted superconducting branch 84 and pass it through another superconducting branch 84, which is still in the superconducting state. The current commutation controlled by the central switch control system 120 may occur at or near a zero-voltage crossing (i.e. at approximate half-wave cycles), or at other times as determined by the power switching characteristics of the mechanical switching system within the central switch control system 120. If the fault is transient and is dissipated before the switching of the elements takes place, then the new superconducting branch 84 will remain in the superconducting state. If the fault persists and the second SMMC element is driven into the normal metallic state, then the process repeats and the central switch control system 120 will commutate the current to the next superconducting branch 84. Clearly, by increasing the number of superconducting branches 84, it is possible to increase the allowable duration of the fault for the device. Also, it is not necessary for the central switch control system 120 to commutate the current immediately. It may be beneficial, for example, to commutate the current at or near a zero-voltage crossing only after the superconducting branch 84 reaches a specified temperature.

Overall, this design results in a very fast system recovery time because the recovery time is not dependent on the thermal characteristics (i.e. heating and cooling rates) of the faulted superconducting branch 84. Rather, the faulted superconducting branch 84 is removed from operation by the central switch control system 120 and allowed to cool under a no-load condition while an alternative element carries the normal load current of the utility grid.

In this example, the central control switching system 120 is actuated by the temperature of the superconducting branch 84. Alternatively, the switching could be triggered by any number or combination of device states including but not limited to temperature, magnetic field, current or voltage levels, cryogen temperature, gas pressure within the cryogenic dewar, AC loss, etc. The superconducting branches 84 may be in the form of bars, rods, tubes, coils or meandering paths fabricated from solid SMMC material or SMMC powder in tube wire or tape. In principle, the variable impedance components may be fabricated using any superconducting material.

The hybrid leads in this design consist of high temperature superconducting material with very low thermal conductivities. Thus the superconducting branches 84 are thermally insulated from the higher temperatures (e.g. >65K), which significantly reduces the cryogenic load of the device at temperature less than 30K. For proper device operation, the critical current of the HTS components must be greater than the critical current of the superconducting branches 84 either alone or if working together in parallel so that the total current flow through the HTS elements does not exceed the critical current of the HTS element in any device configuration.

The multi-element IGD 16A design above operates in a passive mode. In other words, the operation of the device is triggered by the superconducting properties of the superconducting branches 84. The IGD 16A will self-trigger when the current passing through the device exceeds the critical current of the element, or combination of elements. The system is designed to respond to transient faults. In the event of a permanent fault, an in-line breaker can serve to isolate the damaged portion of the grid. Also, the IGD 16A is equipped with a by-pass switching circuit, which can remove the IGD 16A from operation in case of an equipment failure or for routine maintenance.

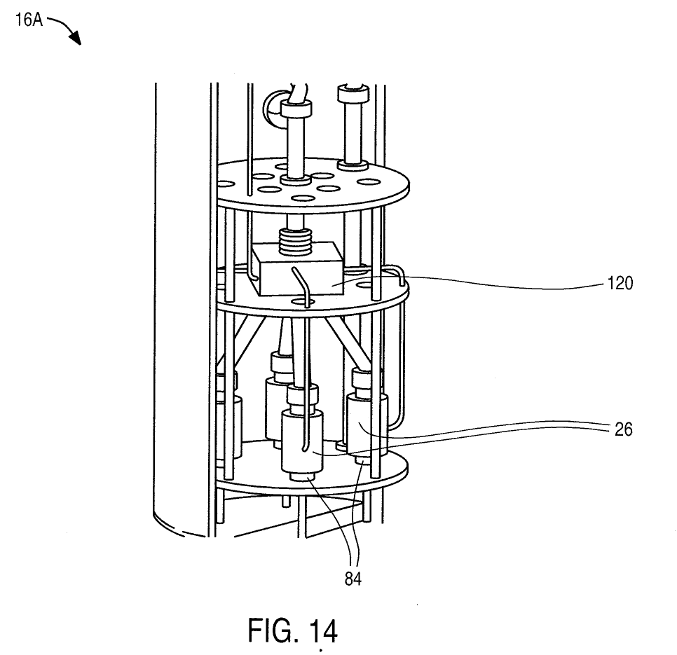

FIG. 14 illustrates aspects of the IGD 16A that allow for the impedance of the IGD to be controlled actively as well as passively. In this system, each superconducting branch 84 is equipped with a respective solenoid element 26, which surrounds the superconducting branch 84. If energized by the central switch control system 120, the solenoid element 26 immerses the superconducting branch 84 in a magnetic field, which then forces the element out of the superconducting state and into the normal metallic state. Thus, the superconducting to normal state transition, which necessarily inserts an impedance into the grid, occurs without a fault condition simply by the application of a sufficiently large magnetic field.

SMMC materials that consist of Type II superconducting particles embedded in a Type I proximity effect superconducting metal (e.g. MgB₂/Ga) are particularly well-suited for this application because the critical magnetic field of the Type I induced superconductor (i.e. the gallium in the MgB₂/Ga SMMC) is sufficiently low that the supercurrent transport may be easily manipulated by applying a modest magnetic field at the surface of the SMMC component with the solenoid. It is well know that Type I superconductors (proximity induced or intrinsic) possess low critical fields and rapidly enter the normal state if the critical magnetic field is exceeded. Type II materials allow the magnetic field to penetrate and thus much higher fields are required to extinguish the superconductivity in these materials with a magnetic field alone.

This IGD 16A is a variable impedance device with passive control with respect to transient fault currents, and active control with respect to longer timescale current flow. The non-contact switch design represented by the application of a magnetic field to bring the SMMC into the normal state is unique in that it is a solid state switch with no moving parts. The “on” state is superconducting and the “off” state is a normal metallic impedance. Unlike mechanical switches, which may be damaged if the switching does not occur at or near a zero-voltage crossing, the switching state in this novel element may be changed at any time during the cycle under AC power conditions. Further, this switching element may also be used in DC applications, though the primary focus of the application is in large network AC power distribution and transmission applications.

In addition to switching the state of the superconducting branch 84 with an applied magnetic field, the state can also be switched by heating the temperature of the element to above the critical temperature of the SMMC. This method, however, may not be as fast as simply applying a magnetic field to the superconducting branch 84. Note also that both AC and DC magnetic fields may be applied to the superconducting branch 84 to drive the superconducting to normal state transition. Further, it may be possible to drive the superconducting to normal state transition of the superconducting branch 84 by bringing high field permanent magnets in close contact to the surface of the superconducting branch 84. In any case, the transition can be initiated by a variety of means (e.g. magnetic or thermal) but will certainly be driven in part by the power dissipated during and after the transition to the normal metallic state.

In the normal-state current-carrying condition, the impedance is inserted into the grid seamlessly and will remain in the network as long as the central switch control system 120 maintains a field in the solenoid 26. The system can be transitioned back to the superconducting state by removing the field and allowing the superconducting branch 84 to cool naturally under normal load conditions (i.e. removing the impedance slowly from the grid), or quickly by switching the normal load current to a fully superconducting branch 84 via the central switch control system 120.

Electric distribution networks consist of many thousands of miles of transmission and distribution lines, step-up and step-down transformers, and a variety of generation sources including very large utility and distributed generation sources. To date, active grid monitoring is primarily performed at large generation facilities where the primary goal is to maintain the phase and frequency integrity of the grid. Smart Grid applications are now being developed that will aid utilities in improving the operation of the grid through an active monitoring program. These Smart Grid applications are largely monitoring devices at the distribution or residential levels, which provide real time data on the flow of power in the grid. These monitoring applications quickly detect when power failures occur and allow for better load balancing at peak demand times. In general, these methods give the utilities improved data collection procedures that they can use to improve the service to the consumer. Advanced monitoring and Smart Grid technologies, however, do not give the utility active control over the operation of the grid, and do not improve the power quality of the grid directly.

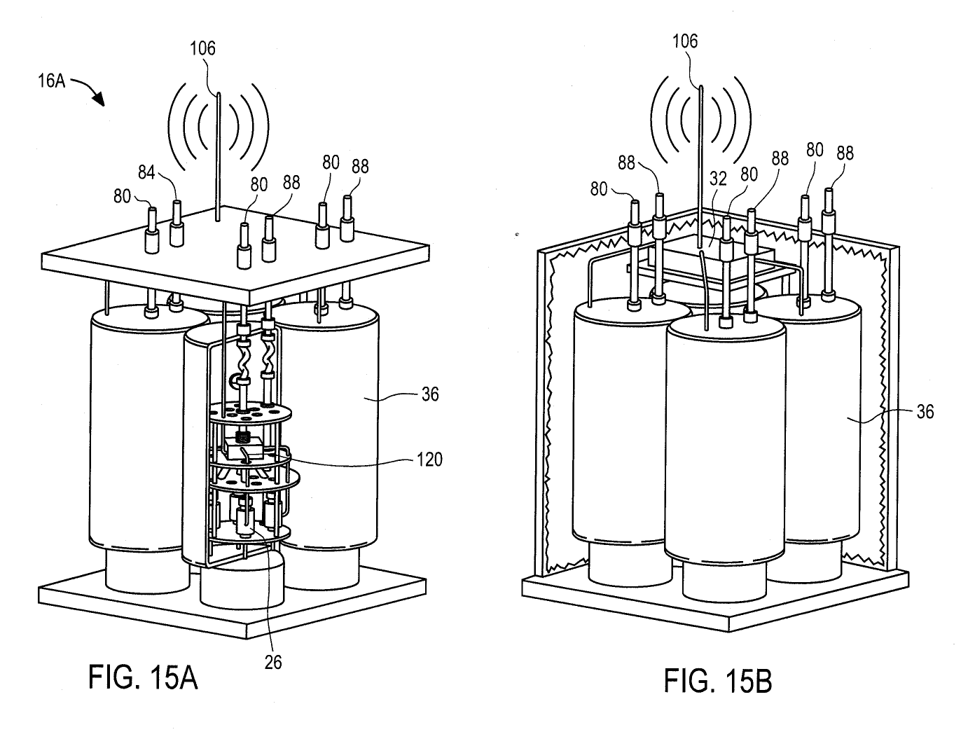

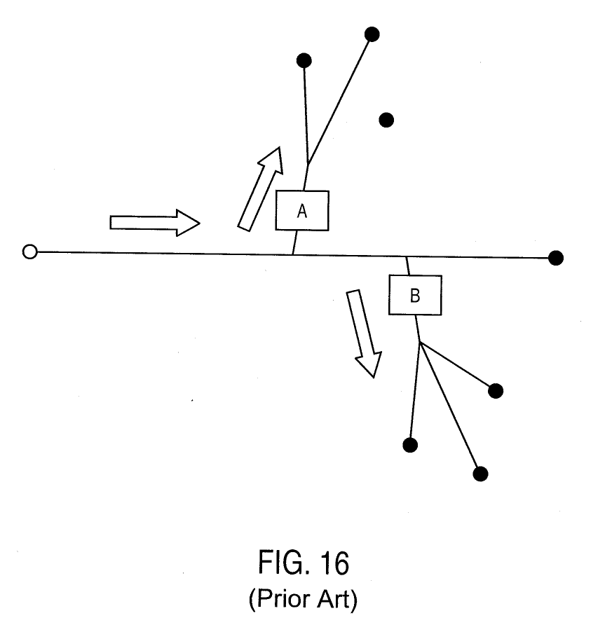

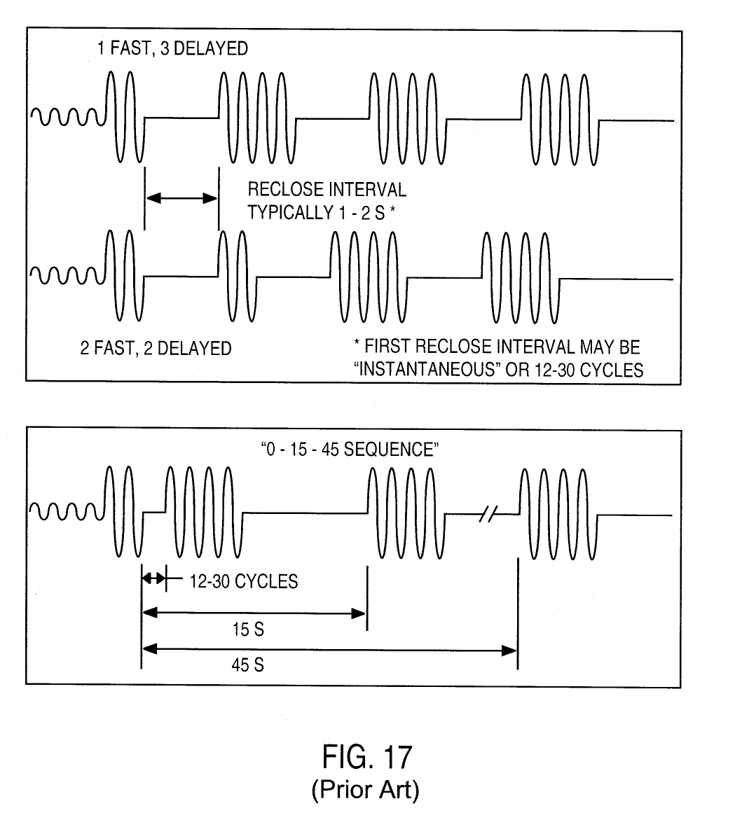

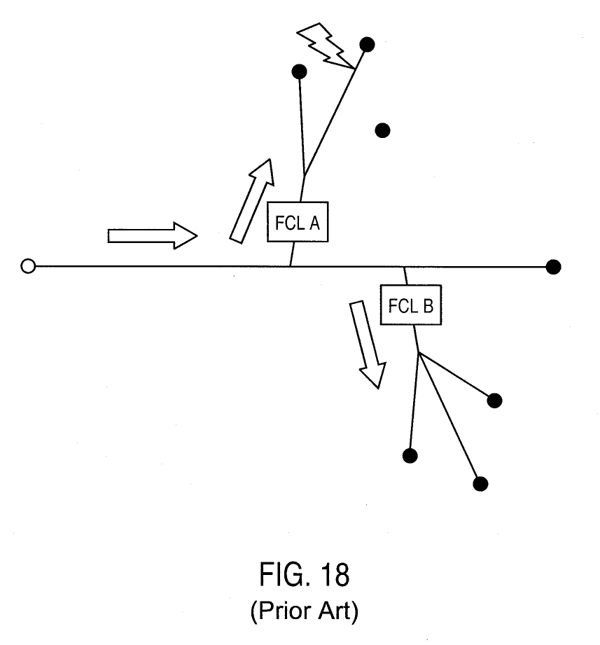

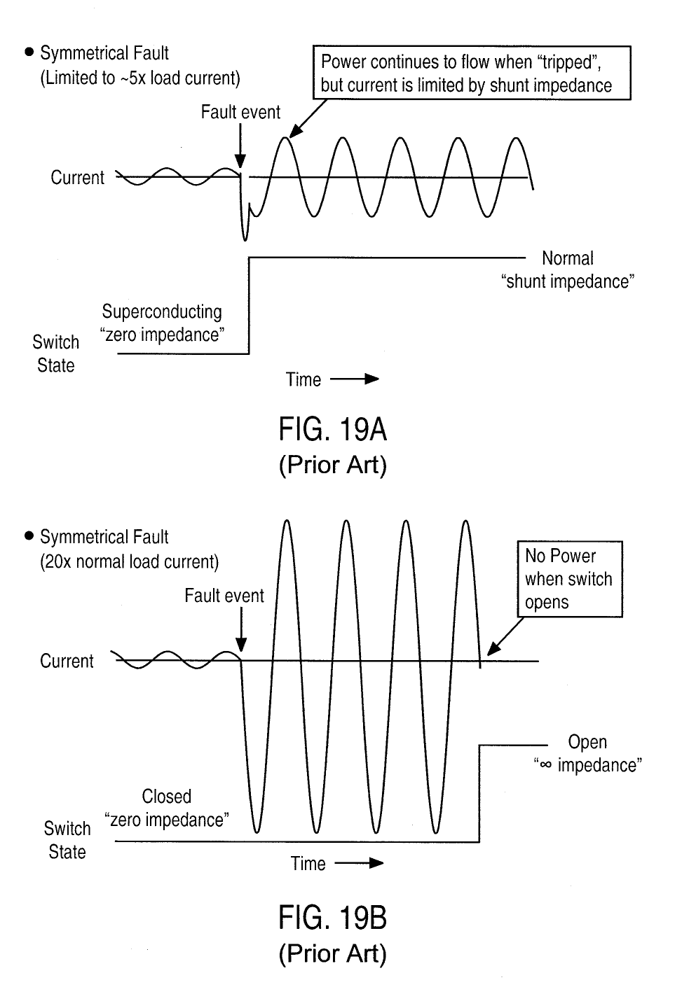

FIGS. 15A and 15B shows aspects relating to integral communication capabilities of the IGD 16A. In the electric utility grid, this device acts as a Smart Grid transducer, fault attenuator, and coordinated grid stabilizer. Thus, the IGD 16A not only monitors the flow of power in the electric grid, but it also has the capacity to stabilize the grid in the event of a fault, or even prevent the fault from occurring in the first place.

The integral communication system 32 is a secure, two-way transmission device links the operation and status of the IGD 16A to the utility and to the nearest, next-nearest neighboring, or in principle any interacting IGD 16A located on the electric grid.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. An electric grid stabilization metadevice comprising:
a plurality of interactive grid devices each forming part of a respective electrical path of an electric grid and each including:
a variable impedance device that inserts a current limiting impedance in the respective path when a fault occurs;
a state detection transducer connected to the variable impedance device to change a detection state when the fault occurs; and
an integral communications system having transmission and reception capabilities and being connected to the state detection transducer and variable impedance device, wherein a fault detected by each of the interactive grid devices automatically causes transmission of a signal to another integrated grid device, reception of the signal by the other integrated grid device and an insertion of a current limiting impedance by the other integrated grid device.

2. The electric grid stabilization metadevice of claim 1, wherein a fault detected by a first of the integrated grid devices causes automatic transmission of a signal to a second of the integrated grid devices and an insertion of a current limiting impedance by the second integrated grid device.

3. The electric grid stabilization metadevice of claim 2, wherein a fault detected by the second integrated grid device causes automatic transmission of a signal to the first integrated grid device and an insertion of a current limiting impedance by the first integrated grid device.

4. The electric grid stabilization metadevice of claim 3, wherein a fault detected by the second integrated grid device causes automatic transmission of a signal to a third of the integrated grid devices and an insertion of a current limiting impedance by the third integrated grid device.

5. The electric grid stabilization metadevice of claim 4, wherein the fault detected by the first of the integrated grid devices causes the insertion of the current limiting impedance by the second integrated grid device without causing the insertion of the current limiting impedance by the third integrated grid device.

6. The electric grid stabilization metadevice of claim 5, wherein the second integrated grid device is nearer to the first integrated grid device than the third integrated grid device.

7. The electric grid stabilization metadevice of claim 5, wherein there is a time delay between the insertion of the current limiting impedance by the second integrated grid device and the insertion of the current limiting impedance by the third integrated grid device.

8. The electric grid stabilization metadevice of claim 2, wherein a fault detected by the second integrated grid device causes automatic transmission of a signal to a third of the integrated grid devices and an insertion of current limiting impedance by the third integrated grid device.

9. The electric grid stabilization metadevice of claim 8, wherein a fault detected by the first integrated grid device causes automatic transmission of a signal to the third integrated grid device and an insertion of a current limiting impedance by the third integrated grid device.

10. The electric grid stabilization metadevice of claim 9, wherein a fault detected by the third integrated grid device causes automatic transmission of a signal to the second integrated grid device and an insertion of a current limiting impedance by the second integrated grid device.

11. The electric grid stabilization metadevice of claim 9, wherein a fault detected by the third integrated grid device causes automatic transmission of a signal to the first integrated grid device and an insertion of a current limiting impedance by the first integrated grid device.

12. The electric grid stabilization metadevice of claim 1, wherein the current limiting impedance allows current to flow through the respective path.

13. The electric grid stabilization metadevice of claim 12, wherein the variable impedance device includes a superconductor branch and a finite impedance shunt branch in parallel, current passing through the superconductor branch if the current is below a critical current of the superconductor branch, and the current through the superconductor branch being reduced by the superconductor branch if the current exceeds the critical current, and increased in the finite impedance shunt branch, to increase an impedance of the superconductor branch and the finite impedance shunt branch in parallel.

14. The electric grid stabilization metadevice of claim 13, further comprising:
an element that is operable to couple and decouple from superconductor material of the superconductor branch, a change in coupling causing a change in resistance of the superconductor branch, the element being connected to the integral communications system so that the integral communications system operates the element in response to reception of the signal.

15. The electric grid stabilization metadevice of claim 14, wherein the element is a solenoid element that creates a magnetic field in the superconductor branch when energized.

16. The electric grid stabilization metadevice of claim 13, wherein the state detection transducer is a thermocouple that detects temperature of the superconductor branch.

17. A method of stabilizing electric power, comprising:
detecting a fault in a grid using a first variable impedance device;
inserting a current limiting impedance in a first path of the grid using the first variable impedance device nearest to the fault;
transmitting a signal from the first variable impedance device to a second variable impedance device following detection of the fault;
receiving the signal at the second variable impedance device; and
inserting a current limiting impedance in a second path of the grid using the second variable impedance device in response to receiving the signal.

18. An interactive grid device comprising:
first and second terminals;
a superconductor component electrically connecting the first and second terminals;
a cooling system, the superconductor component being connected to the cooling system to be cooled to below a critical temperature of superconductor material of the superconductor component to allow for superconducting current to flow through the superconductor component, a fault causing decrease in the superconducting current;
a state detection transducer positioned to change a detection state when the fault occurs; and
an integral communications system connected to the state detection transducer, the integral communications system generating and transmitting a signal when the fault occurs.

19. The method of claim 18, wherein the state detection transducer is a thermocouple that detects temperature of the superconductor branch.

20. The method of claim 18, wherein the variable impedance device includes a superconductor branch and a finite impedance shunt branch in parallel, current passing through the superconductor branch if the current is below a critical current of the superconductor branch, and the current through the superconductor branch being reduced by the superconductor branch if the current exceeds the critical current and increased in the finite impedance shunt branch, to increase an impedance of the superconductor branch and the finite impedance shunt branch in parallel.

21. The method of claim 18, further comprising:
an element that is operable to couple and decouple from superconductor material of the superconductor branch, a change in coupling causing a change in resistance of the superconductor branch, the element being connected to the integral communications system so that the integral communications system operates the element in response to reception of the signal.

22. The method of claim 18, wherein the element is a solenoid element that creates a magnetic field in the superconductor branch when energized.
